(19) United States
(12) Patent Application Publication
(10) Pub. No.: US 2008/0025499 A1
(43) Pub. Date: Jan. 31, 2008

(54) Electronic Mail Management Device

(75) Inventor: Kazuhiro OKADA, Kyoto-shi (JP)

Correspondence Address: HOGAN & HARTSON L.L.P., 1999 AVENUE OF THE STARS, SUITE 1400, LOS ANGELES, CA, 90067, US

(73) Assignee: MURATA KIKAI KABUSHIKI KAISHA, Kyoto-shi (JP)

(21) Appl. No.: 11/769,582

(22) Filed: Jun. 27, 2007

(30) Foreign Application Priority Data
Jul. 27, 2006 (JP) 2006-205075

(51) Int. Cl. H04L 9/28

(52) U.S. Cl. 380/28

(57) ABSTRACT

An internet facsimile terminal. An output control part determines whether a received electronic mail is encrypted. If the electronic mail is not encrypted, the output control part controls an output part to output the electronic mail. If the electronic mail is encrypted, the output control part controls an electronic mail hold part to hold the electronic mail under encryption. A decryption process part decrypts an electronic mail capable of decryption with a decryption key tied to a user among encrypted electronic mails held by the electronic mail hold part in accordance with output instructions from the user. The output control part controls the output part to output the electronic mail decrypted by the decryption process part.

### CROSS-REFERENCE TO RELATED APPLICATIONS

This application claims priority under 35 U.S.C. 119 to Japanese Patent Application No. 2006-2050751 filed on Jul. 27, 2006, which application is hereby incorporated by reference in its entirety.

### BACKGROUND OF THE INVENTION

1. Field of the Invention

The present invention relates to an electronic mail management device.

2. Description of Related Art

Contents of an electronic mail message received at an Internet facsimile terminal are preferably not exposed to a person other than a designated receiver. Further, the contents of the received electronic mail message sometimes need to be handled as confidential information.

When prescribed information is included in a “Subject:” item of a received electronic mail or when a “From:” item of a received electronic mail is preliminarily registered, a known communication terminal device displays only communication management information. Moreover, it has been known that operating an operation part by a user to input a prescribed password and the like allows the whole electronic mail to be printed out.

### SUMMARY OF THE INVENTION

An electronic mail is sometimes sent or received under encryption. In order to read the contents of an encrypted electronic mail, it must be decrypted. It is possible, however, that the encrypted electronic mail will include confidential information. Therefore, there is a need to properly control the timing for decrypting and outputting the encrypted electronic mail.

In view of the above, the invention provides a technology for properly controlling the timing of decrypting and outputting an encrypted electronic mail.

An electronic mail management device according to the invention includes: an electronic mail receive part; a hold part; an output part; an output control part; and a decryption process part. The electronic mail receive part receives an electronic mail. The hold part holds an electronic mail. The output part outputs an electronic mail. The output control part determines whether the electronic mail received by the electronic mail receive part is encrypted or not. The output control part controls the output part to output the electronic mail when it is determined that the electronic mail is not encrypted. The output control part controls the hold part to hold the electronic mail under encryption when it is determined that the electronic mail is encrypted. The decryption process part decrypts an electronic mail capable of decryption with a decryption key tied to a user among encrypted electronic mails held by the hold part in accordance with output instructions from the user. The output control part controls the output part to output the electronic mail decrypted by the decryption process part.

In accordance with the above, a received, encrypted electronic mail is held under encryption until the user gives output instructions. This allows the confidentiality of the electronic mail to be kept. When the user gives output instructions, the electronic mail capable of decryption with the decryption key tied to the user is outputted. This allows the encrypted electronic mail to be decrypted and outputted with a timing preferable for and controlled by the user.

The electronic mail management device according to the invention further includes an operation part for inputting instructions by the user to output the encrypted electronic mail. The decryption process part decrypts an electronic mail capable of decryption with the decryption key tied to the user among encrypted electronic mails held by the hold part in accordance with output instructions from the user through the operation part.

This allows the encrypted electronic mail to be decrypted and outputted when the user directly inputs output instructions to the electronic mail management device.

In the electronic mail management device in accordance with the invention, the output part can be a print process part for printing out the electronic mail. According to the invention, since the encrypted electronic mail can be decrypted and printed out with timing preferable to the user, the confidentiality of the electronic mail can be maintained.

Further, in the case that the output part is the print process part, the print process part prints out contents of an electronic mail after the decryption process part decrypts the electronic mail when a user gives output instructions through the operation part. This allows the user to immediately collect the document, which has been printed out. Accordingly, confidentiality of an electronic mail can be maintained while the electronic mail is printed out.

The electronic mail management device in accordance with the invention may further include a decryption key storage part for correspondingly storing identification information of a user and a decryption key. The decryption process part can accept an input of authentication information corresponding to the identification information from a user to carry out a process of authenticating the user, read out a decryption key corresponding to the user from the decryption storage part when the user is authenticated, and decrypt an electronic mail capable of decryption with the decryption key among the electronic mails held by the hold part.

This allows an electronic mail to be decrypted with a decryption key tied to a user when the user is authenticated, so that the encrypted electronic mail can be easily decrypted and outputted with timing preferable to the user. The authentication information may be a combination of a user ID and a password, for example.

The electronic mail management device in accordance with the invention may further include a record medium accept part for identifying a record medium storing a decryption key therein. The decryption process part can decrypt an electronic mail capable of decryption with the decryption key stored in the record medium identified by the record medium accept part.

The record medium in the above context may be a USB (a universal serial bus) key for storing a use's decryption key and such, a USB token or the like. In the case of a USB key, the decryption process part can read out a decryption key from the USB key identified by the record with the decryption key to decrypt an electronic mail capable of decryption with the decryption key from among the electronic mails held by the hold part. Moreover, the record medium may be arranged to further include authentication information that is used to authenticate the user. In this case, the electronic mail can be decrypted when the user is authenticated. In the case that the record medium has no authentication information, the user may be requested to input authentication information through a key input or the like for authentication and decryption of the electronic mail.

The electronic mail management device in accordance with the invention may be an internet facsimile terminal in which the electronic mail receive part receives a facsimile document as an electronic mail.

Any combination of the above elements and conversion of expression of the invention between a method, a device, a system, a record medium, a computer program and such are also effective as a mode of the invention.

In accordance with the invention, timing for decrypting and outputting an encrypted electronic mail can be properly controlled.

Other features, elements, processes, steps, characteristics and advantages of the present invention will become more apparent from the following detailed description of embodiments of the present invention with reference to the attached drawings.

### BRIEF DESCRIPTION OF THE DRAWINGS

FIG. 1 is a block diagram showing an example of a structure of an internet facsimile terminal in accordance with an embodiment of the invention.

FIG. 2 is a block diagram showing another example of the structure of an internet facsimile terminal in accordance with the invention.

FIG. 3 is a flowchart showing a processing procedure in an internet facsimile terminal in accordance with the invention.

### DETAILED DESCRIPTION OF PREFERRED EMBODIMENTS

Embodiments of the invention are described hereinafter, with reference to the drawings. In the drawings, similar elements are marked with similar signs and numerals and repetitive description thereof is omitted. In the embodiments described herein, an electronic mail management device is an internet facsimile terminal.

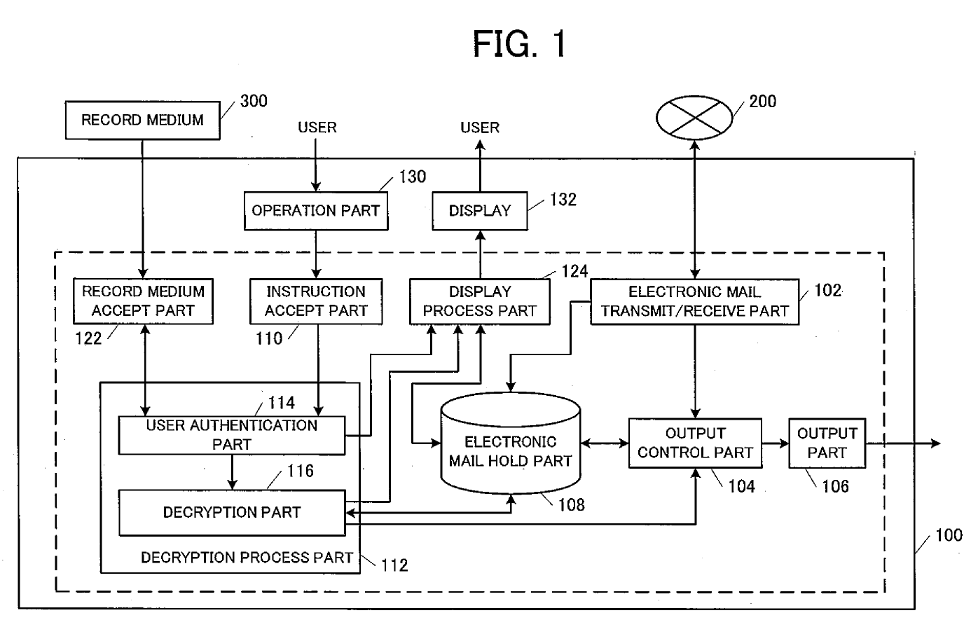

FIG. 1 is a block diagram showing a structure of an internet facsimile terminal 100 in accordance with an embodiment of the invention. The internet facsimile terminal 100 includes an electronic mail transmit/receive part 102, an output control part 104, an output part 106, an electronic mail hold part (a hold part) 108, an instruction accept part 110, a decryption process part 112, a record medium accept part 122, a display process part 124, an operation part 130 and a display 132. The decryption process part 112 includes a user authentication part 114 and a decryption part 116.

The electronic mail transmit/receive part 102 receives an electronic mail from another device through a network 200 such as the Internet, and transmits an electronic mail to another device. In this embodiment, the electronic mail transmit/receive part 102 has a function of transmitting and receiving an electronic mail in an S/MIME (secure multipurpose internet mail extensions) system on the basis of a PKI (public key infrastructure).

An electronic mail received by the electronic mail transmit/receive part 102 is temporarily stored in a memory (not shown). The output control part 104 refers to the memory to determine whether the received electronic mail is encrypted or not, on the basis of a header of the MIME.

The output control part 104 controls the output part 106 to output electronic mail that is not encrypted. In this embodiment, an electronic mail with ordinary writing, or an electronic mail that is only accompanied with an electronic signature and not encrypted, is outputted from the output part 106. The output part 106 is a print process part. That is to say, when the electronic mail is not encrypted, the output part 106 prints out the electronic mail received by the electronic mail transmit/receive part 102. Old data, which has been printed out, is eliminated.

When an electronic mail is encrypted, the output control part 104 controls the output part 106 not to output the encrypted electronic mail, and controls the electronic mail hold part 108 to hold the encrypted electronic mail.

The instruction accept part 110 accepts instructions from a user through the operation part 130. The record medium accept part 122 identifies a record medium 300 detachably mounted to a record medium mount part (not shown). In this embodiment, the record medium 300 may be a USB (universal serial bus) key for storing authentication information of a user, a decryption key and such. The authentication information of a user may be identification information and a password, for example. The record medium accept part 122 identifies the USB key.

On the basis of a user's instructions via instruction accept part 110, the decryption process part 112 decrypts an electronic mail capable of decryption with a decryption key tied to a user among encrypted electronic mails held by the electronic mail hold part 108. This process in the decryption process part 112 is now described.

When the instruction accept part 110 accepts instructions to display an encrypted electronic mail from a user through the operation part 130, the user authentication part 114 reads out authentication information of a user, such as identification information and a password, from the record medium 300 through the record medium accept part 122. The user authentication part 114 authenticates the user on the basis of the authentication information read out from the record medium 300. After the user is authenticated, the user authentication part 114 designates the authenticated user and gives the display process part 124 instructions to display an electronic mail addressed to the user. The display process part 124 reads out the electronic mail addressed to the authenticated user from the electronic mail hold part 108 so that the display 132 displays the electronic mail.

When the instruction accept part 110 accepts selection of an electronic mail to be printed out from the user, the user authentication part 114 reads out a decryption key from the record medium 300. The decryption part 116 uses the decryption key read out from the record medium 300 by means of the user authentication part 114 to decrypt the selected electronic mail.

The output control part 104 controls the output part 106 to output the electronic mail decrypted by the decryption part 116. When the selected electronic mail cannot be decrypted, the decryption part 116 informs the display process part 124 of this fact, and the display process part 124 causes the display 132 to display a message that the decryption cannot be performed.

As described above, in accordance with the internet facsimile terminal 100 in the embodiment of FIG. 1, a user can decrypt and output an encrypted electronic mail with timing that is controlled by the user.

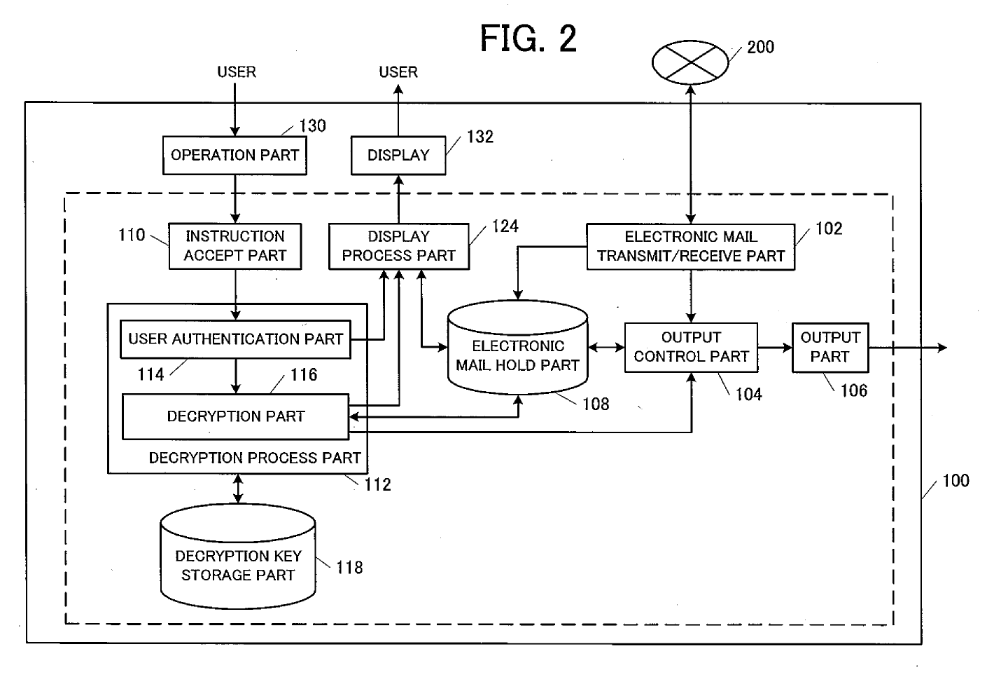

FIG. 2 illustrates a modified example of the internet facsimile terminal 100 of FIG. 1. The internet facsimile terminal 100 of FIG. 2 includes, in addition to the structure shown in FIG. 1, a decryption key storage part 118 for correspondingly storing identification information of a user and a decryption key.

When the instruction accept part 110 accepts the instructions to display an encrypted electronic mail from a user, the user authentication part 114 accepts input of identification information of the user and a password from the user through the instruction accept part 110. The user authentication part 114 then authenticates the user on the basis of the accepted identification information of the user and password. After the user is authenticated, the user authentication part 114 designates the authenticated user and gives the display process part 124 instructions to display an electronic mail addressed to the user. The display process part 124 reads out the electronic mail addressed to the authenticated user from the electronic mail hold part 108 so as to display the electronic mail on the display 132.

When the instruction accept part 110 accepts selection of an electronic mail to be printed out from the user, the decryption part 116 reads out the decryption key corresponding to the authenticated user from the decryption key storage part 118. The decryption part 116 uses the decryption key read out from the decryption key storage part 118 to carry out decryption of the selected electronic mail.

The output control part 104 controls the output part 106 to output the electronic mail decrypted by the decryption part 116. When the selected electronic mail cannot be decrypted, the decryption part 116 informs the display process part 124 of the fact, and the display process part 124 causes the display 132 to display a message that the decryption cannot be performed.

In FIG. 2, the internet facsimile terminal 100 is shown as having no record medium accept part 122. The internet facsimile terminal 100 of FIG. 2, however, may include the record medium accept part 122 similarly to the case shown in FIG. 1. In this case, the user authentication part 114 may carry out a process of authenticating a user on the basis of authentication information recorded in the record medium 300 as the case described with reference to FIG. 1.

As described above, in accordance with the internet facsimile terminal 100 in the embodiment of FIG. 2, a user can decrypt and output an encrypted electronic mail with timing that is controlled by the user.

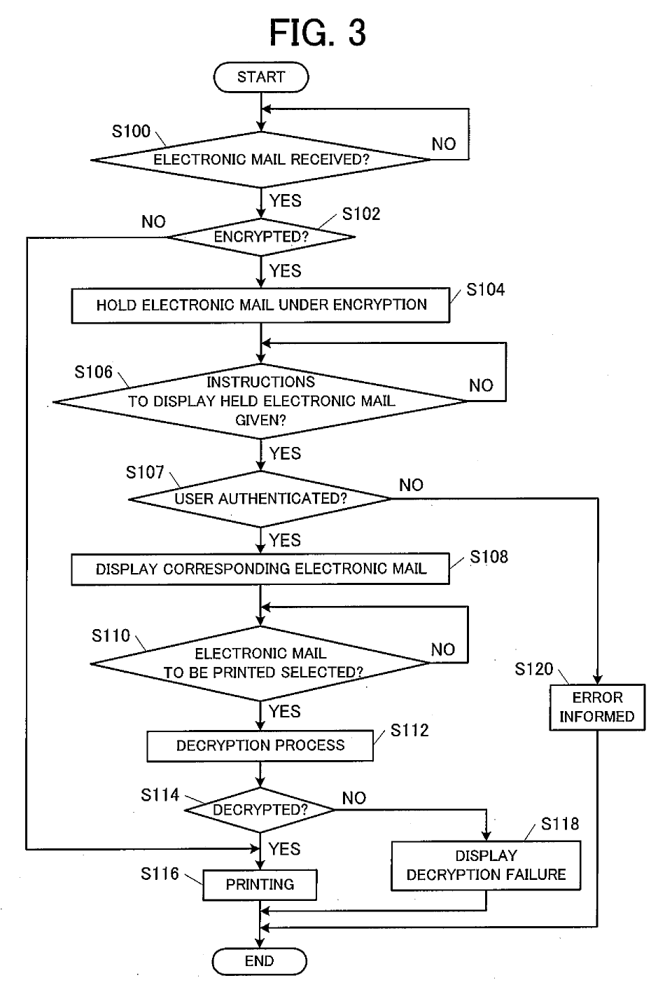

FIG. 3 is a flowchart showing a processing procedure in the internet facsimile terminal 100 in accordance with the embodiments.

When the electronic mail transmit/receive part 102 receives an electronic mail (in the case of “YES” in S100), the output control part 104 determines whether the electronic mail is encrypted or not (S102). In the case that the electronic mail is not encrypted (in the case of “NO” in S102), the output control part 104 controls the output part 106 to immediately print out the electronic mail (S116).

In the case that the electronic mail is encrypted in Step S102 (in the case of “YES” in S102), the output control part 104 controls the output part 106 not to immediately print out the electronic mail. The output control part 104 controls the electronic mail hold part 108 to hold the electronic mail under encryption (S104). The above is an operation of the internet facsimile terminal 100 when the electronic mail transmit/receive part 102 receives an electronic mail. As described above, the output control part 104 switches between an operation that the received electronic mail is immediately printed out and an operation that the received electronic mail is not printed out but held once under encryption in accordance with a determination whether the electronic mail is encrypted or not.

When the instruction accept part 110 accepts instructions to display the electronic mail held by the electronic mail hold part 108 (in the case of “YES” in S106), the user authentication part 114 performs user authentication (S107). After the user is authenticated (in the case of “YES” in S107), the display process part 124 reads out an electronic mail addressed to the user from the electronic mail hold part 108 to display the electronic mail on the display 132 (S108). When the user selects an electronic mail subject to output from displayed electronic mails to give instructions to output the selected electronic mail (in the case of “YES” in S110), the decryption part 116 uses the decryption key stored in the record medium 300 or the decryption key storage part 118 to carry out a decryption process of the selected electronic mail (S112).

The output control part 104 controls the output part 106 to print the electronic mail decrypted in Step S112 (in the case of “YES” in S114) (S116). On the other hand, in the case that an electronic mail, which cannot be decrypted in Step S112, exists (in the case of “NO” in S114), the display process part 124 displays on the display part that decryption has failed (S118). The process is thus completed. In the case that a user cannot be authenticated in Step S107 (in the case of “NO” in Step 107), an error is informed (S120) to complete the process.

As described above, in accordance with the internet facsimile terminal 100 in the embodiment, a user can decrypt and output an encrypted electronic mail with preferable timing.

Each element enclosed by a broken line in the internet facsimile terminal 100 shown in FIGS. 1 and 2 is not shown in a structure per a hardware unit but a block per a function unit. Each element enclosed by a broken line in the internet facsimile terminal 100 is achieved by an optional combination of hardware and software, which mainly consist of a CPU, a memory, a program for achieving the elements in the drawings, the program loaded in a memory, a storage unit such as a hard disk for storing the program and an interface for connecting a network of any computer. A person skilled in the art understands that a method and an apparatus for achieving the above may have various modifications.

The embodiments of the invention have been described hereinbefore with reference to the drawings. The described embodiments, however, are only examples of the invention. Various structures other than those described may be employed.

In FIG. 1, an embodiment of the invention is described in which record medium 300 stores authentication information of a user. Alternatively, the authentication information of a user may not be stored in record medium 300. In this case, a user may input authentication information from the operation part 130 so that authentication of the user can be carried out. In another example, authentication of a user may not be carried out. For example, an authorized user may hold a specific storage medium, and authentication of that specific medium will allow instructions from an authorized user to be discriminated.

In the embodiments, when the user gives instructions to display an electronic mail as shown in Step S106 in FIG. 3, an electronic mail corresponding to the instructions is displayed (S108). The user is arranged to select an electronic mail to be printed out among the displayed electronic mails (S110). The processes in Steps S108 and S110, however, may be omitted. That is to say, it may be possible that the decryption part 116 reads out an electronic mail addressed to a user in accordance with instructions from the user, carries out a decryption process and prints out the decrypted electronic mail.

Further, an example has been described in which an encrypted electronic mail is decrypted and printed out on the basis of instructions of a user. Alternatively, the encrypted electronic mail may be forwarded to another device or such. In the case that the electronic mail is forwarded to another device, the output part 106 is to be a forward process part for forwarding an electronic mail to another device.

While the present invention has been described with respect to embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. An electronic mail management device comprising:
an electronic mail receive part for receiving an electronic mail;
a hold part for holding an electronic mail;
an output part for outputting an electronic mail;
an output control part for determining whether the electronic mail received by the electronic mail receive part is encrypted or not, the output control part controlling the output part to output the electronic mail when it is determined that the electronic mail is not encrypted, and controlling the hold part to hold the electronic mail under encryption when it is determined that the electronic mail is encrypted; and
a decryption process part for decrypting an electronic mail capable of decryption with a decryption key tied to a user among encrypted electronic mails held by the hold part in accordance with output instructions from the user, wherein
the output control part controls the output part to output the electronic mail decrypted by the decryption process part.

2. The electronic mail management device according to claim 1, further comprising
an operation part for inputting instructions by the user to output the encrypted electronic mail, wherein
the decryption process part decrypts an electronic mail capable of decryption with the decryption key tied to the user among encrypted electronic mails held by the hold part in accordance with output instructions from the user through the operation part.

3. The electronic mail management device according to claim 1, wherein
the output part is a print process part for printing out the electronic mail.

4. The electronic mail management device according to claim 1, wherein
the output part is a forward process part for forwarding the electronic mail to another device.

5. The electronic mail management device according to claim 1, further comprising
a decryption key storage part for correspondingly storing identification information of the user and the decryption key, wherein
the decryption process part accepts an input of authentication information corresponding to the identification information from the user to carry out a process of authenticating the user, reads out the decryption key corresponding to the user from the decryption key storage part when the user is authenticated, and decrypts an electronic mail capable of decryption with the decryption key among the electronic mails held by the hold part.

6. The electronic mail management device according to claim 1, further comprising
a record medium accept part for identifying a record medium storing the decryption key therein, wherein
the decryption process part decrypts an electronic mail capable of decryption with the decryption key stored in the record medium identified by the record medium accept part.

7. The electronic mail management device according to claim 1, further comprising:
an operation part for inputting instructions by the user to display the encrypted electronic mail;
a display process part for reading out an electronic mail addressed to the user among encrypted electronic mails held by the hold part to show the read electronic mail on a display in accordance with display instruction from the user through the operation part; and
an accept part for accepting selection of an electronic mail to be outputted among electronic mails shown on the display from the user, wherein
the decryption process part uses the decryption key tied to the user to decrypt the electronic mail selected through the accept part.

8. The electronic mail management device according to claim 7, wherein
the decryption process part informs the display process part that the electronic mail selected through the accept part cannot be decrypted in the case of a failure in decryption and
the display process part controls the display to show a message that the decryption cannot be performed when the display process part receives the information from the decryption process part.

9. The electronic mail management device according to claim 1, wherein
the electronic mail management device is an internet facsimile terminal, and
the electronic mail receive part receives a facsimile document as an electronic mail.

10. An electronic mail management method comprising:
a receiving step for receiving an electronic mail;
a determining step for determining whether the electronic mail received in the receiving step is encrypted or not;
a first outputting step for outputting the electronic mail received in the receiving step when it is determined that the electronic mail is not encrypted;
a holding step for holding the electronic mail received in the receiving step under encryption when it is determined that the electronic mail is encrypted;
an accepting step for accepting output instructions from a user after holding the electronic mail in the holding step;
a decryption processing step for decrypting an electronic mail capable of decryption with a decryption key tied to the user among encrypted electronic mails held in the holding step in accordance with output instructions accepted from the user in the accepting step; and
a second outputting step for outputting the electronic mail decrypted in the decryption processing step.

11. The electronic mail management method according to claim 10, wherein
output instructions through an operation by the user are accepted in the accepting step.

12. The electronic mail management method according to claim 10, wherein
an electronic mail is printed out in the first outputting step and the second outputting step.

13. The electronic mail management method according to claim 10, wherein
an electronic mail is forwarded to another device in the first outputting step and the second outputting step.

14. The electronic mail management method according to claim 10, further comprising:
a decryption key storing step for correspondingly storing identification information of the user and a decryption key; and
an authenticating step for accepting an input of authentication information corresponding to the identification information from the user to carry out a process of authenticating the user, wherein
the decryption key stored correspondingly to the user in the decryption key storing step is read out when the user is authenticated in the authenticating step and an electronic mail capable of decryption with the decryption key is decrypted among the electronic mails held in the holding step in the decryption processing step.

15. The electronic mail management method according to claim 10, further comprising
a record medium accepting step for identifying a record medium storing the decryption key therein, wherein
an electronic mail capable of decryption with the decryption key stored in the record medium identified in the record medium accepting step is decrypted in the decryption processing step.

16. The electronic mail management method according to claim 10, further comprising:
a display instruction accepting step for accepting instructions to display an electronic mail held in the holding step from the user;
a first display step for reading out and displaying an electronic mail addressed to the user among electronic mails held in the holding step in accordance with the display instructions from the user in the display instruction accepting step; and
a selection accepting step for accepting selection of an electronic mail to be outputted among the electronic mails displayed in the display step from the user, wherein
the decryption key tied to the user is used to decrypt the electronic mail selected in the selection accepting step in the decryption processing step.

17. The electronic mail management method according to claim 16, further comprising:
a second display step for displaying a message that the electronic mail selected in the selection accepting step cannot be decrypted in case of a failure of decryption.

18. The electronic mail management method according to claim 10, wherein
a facsimile document is received as an electronic mail in the receiving step.

19. An electronic mail management method comprising:
receiving an electronic mail;
determining whether the received electronic mail is encrypted;
outputting the received electronic mail when it is not encrypted;
holding the electronic mail when it is encrypted until instructions are received from a user to output the held electronic mail;
authenticating the user;
decrypting the held electronic mail; and
outputting the decrypted electronic mail.

20. The electronic mail management method according to claim 19, wherein the held electronic mail is decrypted using a decryption key stored in either an external record medium or an internal storage part.
